(19) United States
(12) Patent Application Publication
(10) Pub. No.: US 2013/0235493 A1
(43) Pub. Date: Sep. 12, 2013

(54) PROTECTION CIRCUIT AND POWER MANAGEMENT CIRCUIT AND ELECTRONIC DEVICE

(71) Applicant: Lu-Qing MENG, Shenzhen City (CN)

(72) Inventor: Lu-Qing MENG, Shenzhen City (CN)

(21) Appl. No.: 13/652,529

(22) Filed: Oct. 16, 2012

(30) Foreign Application Priority Data
Mar. 9, 2012 (CN) 201210061076.6

(51) Int. Cl. H02H 9/04

(52) U.S. Cl. 361/18; 361/56

(57) ABSTRACT

An electronic device includes a power supply for providing a supply voltage, an interface circuit electrically connected to an external device, a switch circuit and a protection circuit. The switch circuit is connected between the power supply and the protection circuit, and is capable of being turned on to transmit a supply voltage from the power supply to the interface circuit through the protection circuit for powering the interface circuit or can be turned off to stop transmitting the supply voltage. When the external device generates a large reverse voltage, it is transmitted to the protection circuit through the interface circuit, and the protection circuit eliminates the reverse voltage.

### BACKGROUND

1. Technical Field

The present disclosure relates to a protection circuit; and more particularly, to an electronic device and a power management circuit having the protection circuit.

2. Description of Related Art

Interface circuits, such as High Definition Multimedia Interface (HDMI) circuit and Universal Serial BUS (USB) interface circuit are widely used in electronic devices, for example, in digital versatile disc (DVD) players, notebook computers and the like. Generally, an electronic device includes a power supply, a switch circuit and an interface circuit. The interface circuit is electrically connected to an external device. The switch circuit is connected between the power supply and the interface circuit for establishing or cutting off an electrical connection between the power supply and the interface circuit in response to user's operations. However, when the external device generates a reverse voltage which is transmitted to the switch circuit through the interface circuit and the reverse voltage is larger than the supply voltage, the reverse voltage may destroy the switch circuit. The reverse voltage may even destroy the power supply itself.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the two views.

FIG. 1 is a block diagram showing an electronic device in accordance with one embodiment.

FIG. 2 is a circuit diagram of the electronic device in FIG. 1 in accordance with one embodiment.

### DETAILED DESCRIPTION

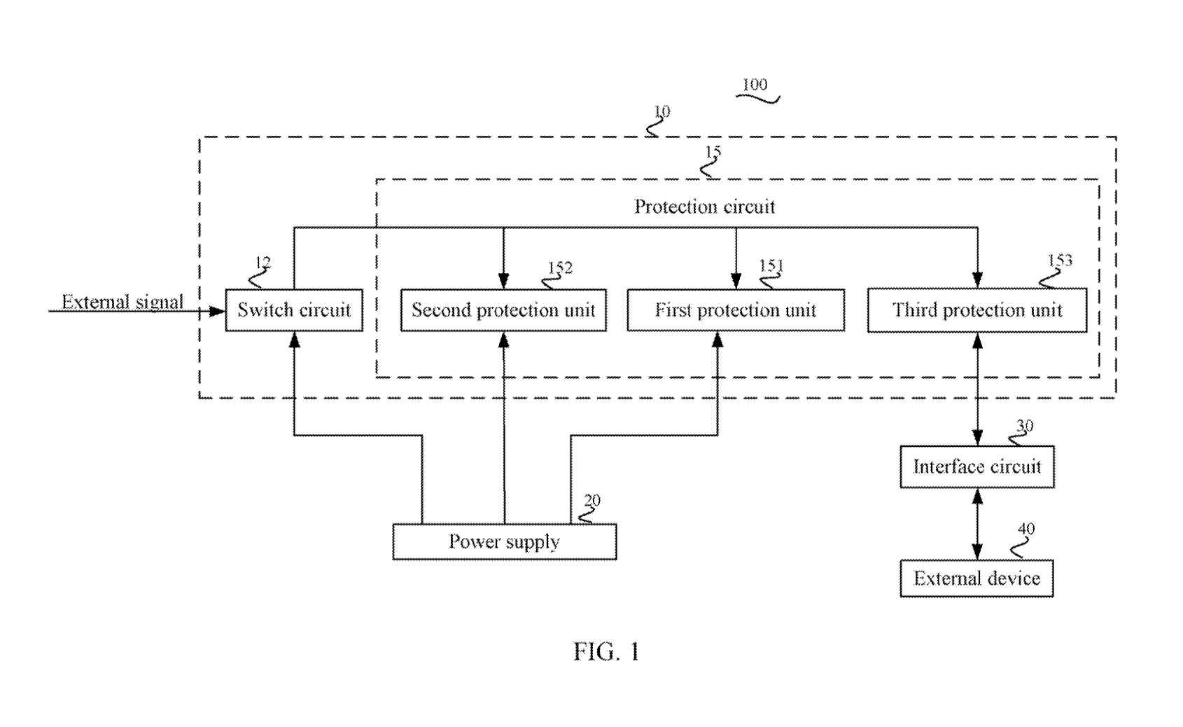

Referring to FIG. 1, an electronic device 100 includes a power manager circuit 10, a power supply 20 and an interface circuit 30. The power manager circuit 10 is connected between the power supply 20 and the interface circuit 30. The interface circuit 30 is connected to an external device 40. The electronic device 100 can be a digital versatile disc (DVD) player or a notebook computer. The interface circuit 30 can be a high definition multimedia interface (HDMI) circuit, a universal serial bus (USB) interface circuit, or the like. In the embodiment, the electronic device 100 is a digital versatile disc (DVD) player. The interface circuit 30 is a high definition multimedia interface (HDMI) circuit.

The power manager circuit 10 includes a switch circuit 12 and a protection circuit 15. The switch circuit 12 is connected between the power supply 20 and the protection circuit 15. The protection circuit 15 is connected to the interface circuit 30.

The switch circuit 12 is turned on or turned off to establish or cut off an electrical connection between the power supply 20 and the interface circuit 30, according to an external signal. In the embodiment, the external signal may be generated in response to user's operations, for example, when a user presses or triggers a key disposed on the electronic device 100, the external signal is generated and is transmitted to the switch circuit 12.

When the switch circuit 12 is turned on and establishes an electrical connection between the power supply 20 and the interface circuit 30, the switch circuit 12 transmits a supply voltage from the power supply 20 to the interface circuit 30 through the protection circuit 15 for powering the interface circuit 30. When the switch circuit 12 is turned off and cuts off the electrical connection between the power supply 20 and the interface circuit 30, the switch circuit 12 stops transmitting the supply voltage.

The protection circuit 15 is further connected to the power supply 20 for receiving the supply voltage. When the external device 40 generates a reverse voltage which is transmitted to the protection circuit 15 through the interface circuit 30 and the reverse voltage is larger than the supply voltage, the protection circuit 15 eliminates the reverse voltage.

In detail, the protection circuit 15 includes a first protection unit 151, a second protection unit 152, and a third protection unit 153. The third protection unit 153 is connected between the switch circuit 12 and the interface circuit 30. The first protection unit 151 is connected to the switch circuit 12 and the third protection unit 153. The first protection unit 151 is connected to the second protection unit 152. The first protection unit 151 is further connected to the power supply 20 for receiving the supply voltage. The second protection unit 152 is connected to the switch circuit 12 and the third protection unit 153. The second protection unit 152 is further connected to the power supply 20 for receiving the supply voltage.

When the external device 40 generates a reverse voltage, it is transmitted to the second protection unit 152 and the first protection unit 151 through the interface circuit 30 and the third protection unit 153 and if the reverse voltage is larger than the supply voltage, the reverse voltage charges the second protection unit 152 to accumulate a charged voltage, and the first protection unit 151 discharges the charged voltage for the purpose of eliminating the charged voltage. Therefore, the protection circuit 15 eliminates the reverse voltage, and the switch circuit 12 and the power supply 20 are effectively protected.

In other embodiments, the second protection unit 152 is deleted from the protection circuit 15, that is, the protection circuit 15 does not include the second protection unit 152. In this situation, when the external device 40 generates a reverse voltage which is transmitted to the first protection unit 151 through the interface circuit 30 and the third protection unit 153, and the reverse voltage is larger than the supply voltage, it is the first protection unit 151 which discharges and eliminates the reverse voltage. Therefore, the switch circuit 12 and the power supply 20 are also effectively protected in this other embodiment.

When the switch circuit 12 is turned on, the power supply 20 provides a supply voltage which is transmitted to the interface circuit 30 through the protection circuit 15. In this state, the third protection unit 153 is capable of eliminating any overcurrent to protect the interface circuit 30. Therefore, the interface circuit 30 is in a normal state and can exchange data with the external device 40. When the external device 40 generates any overcurrent which flows to the third protection unit 153 through the interface circuit 30, the third protection unit 153 eliminates the overcurrent for the purpose of protecting the switch circuit 12 and the power supply 20.

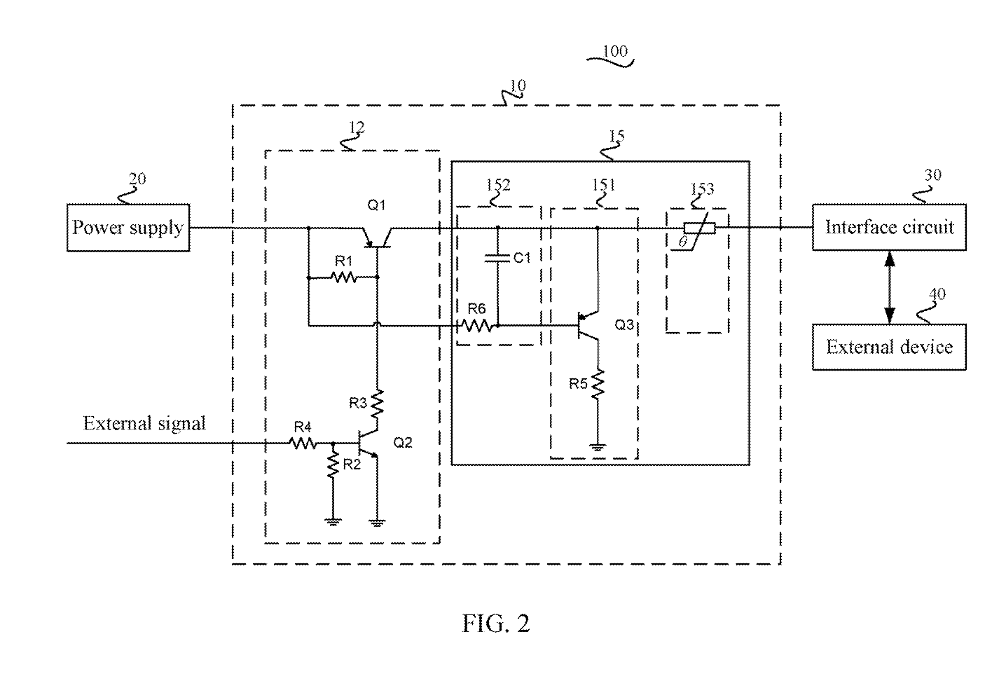

Referring to FIG. 2, the switch circuit 12 includes a first transistor Q1, a first resistor R1, a second transistor Q2, a second resistor R2, a third resistor R3, and a fourth resistor R4. A base of the first transistor Q1 is connected to the third resistor R3, a collector of the first transistor Q1 is connected to the second protection unit 152, and an emitter of the first transistor Q1 is connected to the power supply 20. One end of the first resistor R1 is connected between the base of the first resistor R1 and the third resistor R3, the other end of the first resistor R1 is connected between the emitter of the first transistor Q1 and the power supply 20. In the embodiment, the first transistor Q1 is a PNP type transistor. Abase of the second transistor Q2 is grounded through the second resistor R2, an emitter of the second transistor Q2 is grounded, and a collector of the second transistor Q2 is connected to the base of the first transistor Q1 through the third resistor R3. The base of the second transistor Q2 receives the external signal through the fourth resistor R4. In the embodiment, the second transistor Q2 is a NPN type transistor.

The first protection unit 151 includes a third transistor Q3 and a fifth resistor R5. The second protection unit 152 includes a capacitor C1 and a sixth resistor R6. A base of the third transistor Q3 is connected to the power supply 20 through the sixth resistor R6, a collector of the third transistor Q3 is grounded through the fifth resistor R5, and an emitter of the third transistor Q3 is connected to one end of the first capacitor C1. The first capacitor C1 is connected between the base and the emitter of the third transistor Q3. In the embodiment, the third transistor Q3 is NPN type transistor.

The third protection unit 153 is a positive temperature coefficient thermistor P1. The thermistor P1 is connected between the third transistor Q3 and the interface circuit 30. The interface circuit 30 is connected to the external device 40.

The principle of the power manager circuit 10 is illustrated as follows:

When the base of the second transistor Q2 receives an external signal which is high level through the fourth resistor R4, the second transistor Q2 turns on, thus, the first transistor Q1 also turns on. In this state, the supply voltage from the power supply 20 is transmitted to the interface circuit 30 through the protection unit 15. Thus, the interface circuit 30 is in a normal state and can exchange data with the external device 40.

When a reverse voltage from the external device 40 is transmitted to the emitter of the third transistor Q3, and the reverse voltage is larger than the voltage across the first capacitor C1 with respect to the base of the third transistor Q3, the second protection unit 152 is charged with the reverse voltage. At the same time, the voltage of the emitter of the third transistor Q3 is larger than the voltage at the base of the third transistor Q3, and the first capacitor C1 is discharged through the fifth resistor R5. Therefore, the second protection unit 152 and the first protection unit 151 effectively eliminate any reverse voltage, for protecting the switch circuit 12 and the power supply 20.

Although information and the advantages of the present embodiments have been set forth in the foregoing description, together with details of the structures and functions of the present embodiments, the disclosure is illustrative only; changes may be made in detail, especially in the matters of shape, size, and arrangement of parts within the principles of the present embodiments to the full extent indicated by the broad general meaning of the terms in which the appended claims are expressed.

What is claimed is:

1. A protection circuit connected between a switch circuit and an interface circuit, the interface circuit being electrically connected to an external device, the switch circuit being capable of being turned on to transmit a supply voltage from a power supply to the interface circuit through the protection circuit for powering the interface circuit or being turned off to stop transmitting the supply voltage, the protection circuit comprising;
a first protection unit connected to the switch circuit and the interface circuit, the first protection unit further connected to the power supply for receiving the supply voltage;
wherein when the external device generates a reverse voltage which is transmitted to the protection circuit through the interface circuit and the reverse voltage is larger than the supply voltage, the first protection unit discharges the reverse voltage for the purpose of eliminating the reverse voltage.

2. The protection circuit as claimed in claim 1, wherein the first protection unit comprises a first resistor and a first transistor; the base of the first transistor is connected to the power supply, the emitter of the first transistor is connected to between the switch unit and the interface circuit, the collector of the first transistor is grounded through the first resistor.

3. The protection circuit as claimed in claim 1, further comprising a second protection unit, the second protection unit is connected to the switch circuit and the interface circuit, the second protection unit is further connected to the power supply for receiving the supply voltage; the first protection unit is connected to the second protection unit; when the reverse voltage is transmitted to the second protection unit through the interface circuit and the reverse voltage is larger than the supply voltage, the reverse voltage charges the second protection unit to generate a charged voltage, and the first protection unit discharges the charged voltage.

4. The protection circuit as claimed in claim 3, wherein the second protection unit comprises a first capacitor, one end of the first capacitor is connected between the switch circuit and the interface circuit, the other end of the first capacitor is connected to the power supply.

5. The protection circuit as claimed in claim 4, wherein the first protection unit further comprises a first resistor and a first transistor; the base of the first transistor is connected to the power supply, the emitter of the first transistor is connected to one end of the first capacitor, the collector of the first transistor is grounded through the first resistor; the first capacitor is connected between the base and the emitter of the first transistor.

6. The protection circuit as claimed in claim 1, further comprising a third protection unit connected between the switch circuit and the interface circuit, when the external device generates an overcurrent, the third protection unit discharges the overcurrent.

7. The protection circuit as claimed in claim 6, wherein the third protection unit is a positive temperature coefficient thermistor, the positive temperature coefficient thermistor is connected between the switch circuit and the interface circuit.

8. A power management circuit connected between a power supply and an interface circuit, the interface circuit electrically connected to an external device, the power management circuit comprising:
a protection circuit connected to the interface circuit; and
a switch circuit connected between the power supply and the protection circuit, the switch circuit capable of being turned on to transmit a supply voltage from the power supply to the interface circuit through the protection circuit for powering the interface circuit or being turned off to stop transmitting the supply voltage;
wherein the protection circuit is further connected to the power supply for receiving the supply voltage, when the external device generates a reverse voltage which is transmitted to the protection circuit through the interface circuit and the reverse voltage is larger than the supply voltage, the protection circuit eliminates the reverse voltage.

9. The power management circuit as claimed in claim 8, wherein the protection circuit comprises a first protection unit and a second protection unit; the first protection unit is connected to the second protection unit, the second protection unit is connected to the switch circuit and the interface circuit, the second protection unit is further connected to the power supply for receiving the supply voltage from the power supply; when the reverse voltage which is transmitted to the second protection unit through the interface circuit is larger than the supply voltage, the reverse voltage charges the second protection unit to generate a charged voltage, and the first protection unit discharges the charged voltage for eliminating the reverse voltage.

10. The power management circuit as claimed in claim 9, wherein the second protection unit comprises a first capacitor, one end of the first capacitor is connected between the switch circuit and the interface circuit, the other end of the first capacitor is connected to the power supply.

11. The power management circuit as claimed in claim 10, wherein the first protection unit comprises a first resistor and a first transistor; the base of the first transistor is connected to the power supply, the emitter of the first transistor is connected to one end of the first capacitor, the collector of the third transistor is grounded through the first resistor; the first capacitor is connected between the base and the emitter of the first transistor.

12. The power management circuit as claimed in claim 8, wherein the protection circuit comprises a first protection unit connected to the switch circuit and the interface circuit, the first protection unit is further connected to the power supply for receiving the supply voltage from the power supply; when the reverse voltage is transmitted to the second protection unit through the interface circuit and the reverse voltage is larger than the supply voltage, the first protection unit discharges the reverse voltage.

13. The power management circuit as claimed in claim 8, wherein the protection circuit comprises a third protection unit connected between the switch circuit and the interface circuit, when the external device generates an overcurrent, the third protection unit eliminates the overcurrent.

14. The power management circuit as claimed in claim 13, wherein the third protection unit is a positive temperature coefficient thermistor, the positive temperature coefficient thermistor is connected between the switch circuit and the interface circuit.

15. An electronic device, comprising:
a power supply for providing a supply voltage;
an interface circuit electrically connected to an external device;
a protection circuit connected to the interface circuit; and
a switch circuit connected between the power supply and the protection circuit; the switch circuit capable of being turned on to transmit the supply voltage to the interface circuit through the protection circuit for powering the interface circuit or being turned off to stop transmitting the supply voltage;
wherein the protection circuit is further connected to the power supply for receiving the supply voltage, when the external device generates a reverse voltage which is transmitted to the protection circuit through the interface circuit and the reverse voltage is larger than the supply voltage, the protection circuit eliminates the reverse voltage.

16. The electronic device as claimed in claim 15, wherein the protection circuit comprises a first protection unit and a second protection unit; the first protection unit is connected to the second protection unit, the second protection unit is connected to the switch circuit and the interface circuit, the second protection unit is further connected to the power supply for receiving the supply voltage from the power supply; when the reverse voltage which is transmitted to the second protection unit through the interface circuit and the reverse voltage is larger than the supply voltage, the reverse voltage charges the second protection unit to generate a charged voltage, and the first protection unit discharges the charged voltage.

17. The electronic device as claimed in claim 16, wherein the second protection unit comprises a first capacitor, one end of the first capacitor is connected between the switch circuit and the interface circuit, the other end of the first capacitor is connected to the power supply.

18. The electronic device as claimed in claim 17, wherein the first protection unit comprises a first resistor and a first transistor; the base of the first transistor is connected to the power supply, the emitter of the first transistor is connected to one end of the first capacitor, the collector of the third transistor is grounded through the first resistor; the first capacitor is connected between the base and the emitter of the first transistor.

19. The electronic device as claimed in claim 15, wherein the protection circuit comprises a first protection unit connected to the switch circuit and the interface circuit, the first protection unit is further connected to the power supply for receiving the supply voltage from the power supply; when the reverse voltage is transmitted to the first protection unit through the interface circuit and the reverse voltage is larger than the supply voltage, the first protection unit discharges the reverse voltage.

20. The electronic device as claimed in claim 15, wherein the protection circuit comprises a third protection unit connected between the switch circuit and the interface circuit, when the external device generates an overcurrent which is flowed to the third protection unit through the interface circuit, the third protection unit discharges the overcurrent.
